(19) United States
(12) Patent Application Publication
(10) Pub. No.: US 2017/0236179 A1
(43) Pub. Date: Aug. 17, 2017

(54) SERVICE MONITORING AND OPTIMIZATION SYSTEMS AND METHODS

(71) Applicants: Henry Dreifus, Sanford, FL (US); Leonard Schenker, Boca Raton, FL (US)

(72) Inventors: Henry Dreifus, Sanford, FL (US); Leonard Schenker, Boca Raton, FL (US)

(21) Appl. No.: 15/043,993

(22) Filed: Feb. 15, 2016

(51) Int. Cl. G06Q 30/06

(52) U.S. Cl. CPC G06Q 30/0627; H04M 15/80

(57) ABSTRACT

A system and method for selecting an optimal service may include: (1) querying a device to determine the location at which the service is provided and the parameters of the service being used, (2) based on the information obtained from the query, comparing the parameters of competing services offered in the location, and (3) based on the comparison, selecting one of the competing services.

### FIELD OF THE INVENTION

The present invention relates to systems and methods for optimizing the use of a service, and in particular to systems and methods for evaluating, selecting, and monitoring the use of a service selected from among a plurality of services.

### BACKGROUND OF THE INVENTION

Seeking and obtaining the optimal service, such as a cable/satellite/internet service for an interactive television, phone or mobile device, is dependent on a number of factors—including location, usage needs, costs, contract length (if any), costs associated, available services that are offered, and the like. The object of this invention is to provide an automated way to discover, select and continuously optimize the service provisioning, for example for an electronic device.

For consumers, the challenge and complexity of finding the optimal service for a device, either immediately at the moment of initial purchase, or later after the device is in use, may be difficult. There are many attributes that a consumer discovers, analyzes and considers when selecting and purchasing a product—for which some products/services may include or be bundled with term, fee-based subscription service(s). One example is the communications industry in the United States, which commonly offers bundles that include a mobile phone and a mobile service network plan/contract that obligates a customer to the service provider for a period of time. These contracts often discount the purchase up-front price of the mobile phone, but force the customer into a long-term contractual relationship. Similarly, many United States households receive their television programming via cable or internet versus over the air broadcast. These services are increasingly becoming internet-based—and may include a “set top” box or device directly interconnected. Such a device may be provided by the service operator or purchased either separately, or internal to the television or monitor. As this is a complex process, a consumer may not know the changing options and alternatives available with respect to any particular service or device, and thus it may be difficult for the consumer to easily determine the best price/value for his/her needs.

Additionally, certain services and devices are made available to consumers with various options for up-front cost vs. total cost of purchase and/or ownership over the useful life of the device and/or service. For example, mobile phones may be offered to consumers without contract for a “full retail” price, offered at a discount price in connection with a contractual service obligation to a service provider for a period of time (for example, two years), and/or offered at a discount as part of a limited-time promotion and/or sale. Yet further, various service contracts often incorporate early termination penalties and/or buy-out provisions that must be considered when evaluating the total cost of a device and/or service under a particular usage scenario.

Further, the challenge is not static—such as moving to a new home in a different city, or over the course of time the competitive evolution and changes of offers and providers, coupled with the changing needs and usage is challenging. Today, it is not an easy task to even know in a timely way certain basic information, for example: What are the available providers, options, packages, transaction costs for switching, etc. (both for terminating and initiating service)? Additionally, this information is usually not organized in a way to easily evaluate this information to make an informed optimized decision.

Service offerings may also set limitations—such as speed/bandwidth, consumption meters and/or throttles for usage, or finite number of events such as call minutes, text messages, etc. that can lead to expensive consequences if such limits are exceeded. Thus, finding an optimal provider and service option provides a new and novel approach to continuously minimizing costs, for example costs associated with use of a service on a mobile device.

### SUMMARY OF THE INVENTION

The present invention automatically provides the instant ability (as well as continuous over the life-time of the product/service ability) for a customer to achieve the most desirable outcome for the particular consumer with respect to a type of service, particularly providing all features desired by the consumer at the lowest cost. Further, consumer selection of a service may be immediately “pressure driven” because of time constraints or other factors—which may lock the customer into a poor option that does not properly address his/her needs, or incurs costs at a level more than required and/or necessary. The “most desirable outcome” for a particular consumer may vary over time, and may also vary from consumer to consumer. For example, for a consumer operating on a tight budget, price considerations may be primary in determining the most desirable outcome. In another example, for a consumer desiring high reliability, a high level of service may be primary in determining the most desirable outcome.

In various exemplary embodiments, informing a service provisioning decision utilizes important data aspects that may be gathered, evaluated and algorithmically processed to determine viability and then rank/measure the available choices. This process may start with identifying the device's location(s), from which the available providers can be determined. Once the location where the device is located is understood, a subsequent step is to establish the viable providers for a particular service—which could include both over the air (wireless), over the cable, over the phone line or over the power line as example methods of communication. Once the available providers are identified, then the next step is to determine the service options and costs available from each provider, for example based on the duty cycle, and usage needs—either user selected or longitudinally calculated by the device as measured by its usage pattern.

This summary is provided as a simplified introduction to the disclosure, and is not intended to limit the scope of any claim.

### BRIEF DESCRIPTION OF THE DRAWINGS

FIG. 1A illustrates an embodiment wherein a service optimization system is operative on an electronic device utilizing a service to be optimized in accordance with various exemplary embodiments of the invention.

FIG. 1B illustrates an embodiment wherein a service optimization system is a separate device from an electronic device utilizing a service to be optimized in accordance with various exemplary embodiments of the invention.

FIG. 1C illustrates an embodiment wherein a service optimization system is a networked and/or distributed computing system in communication with an electronic device utilizing a service to be optimized in accordance with various exemplary embodiments of the invention.

FIG. 2 illustrates a flowchart for a method of optimizing a service in accordance with various exemplary embodiments of the invention.

### DETAILED DESCRIPTION OF PREFERRED EMBODIMENTS

While specific examples herein are discussed in terms of “electronic devices” and services utilized by such electronic devices, it will be appreciated that principles of the present disclosure are applicable to other services as well, for example utility services, health care services, labor services, motor vehicle sharing (or use or rental) services, and the like, and the examples herein are given by way of reference and not of limitation.

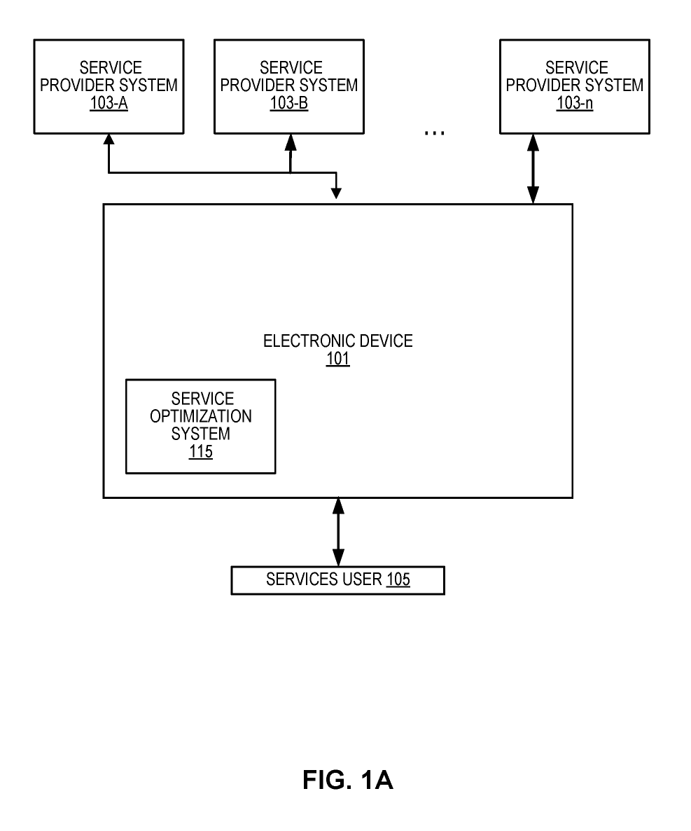

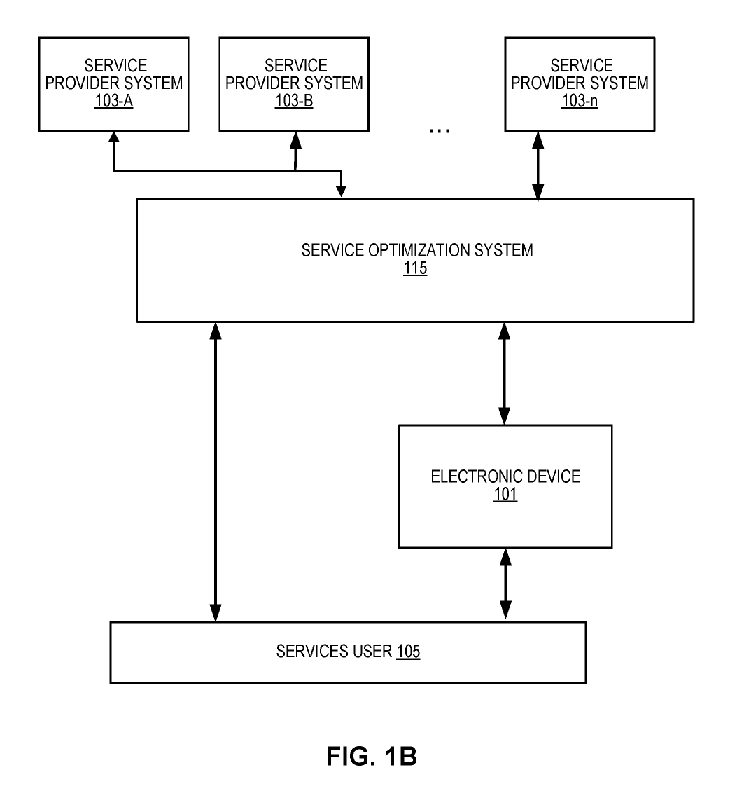

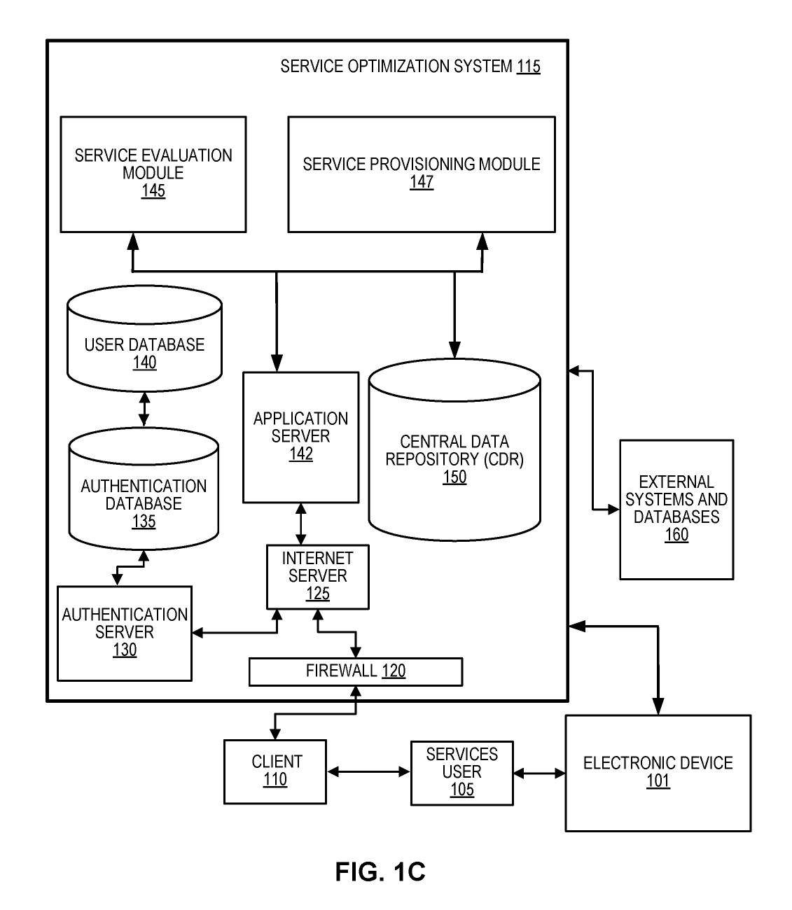

With reference now to FIG. 1A, in various embodiments, a service optimization system 115 may be operative as software application on an electronic device 101. Electronic device 101 may be in communication with one or more service provider systems 103-A through 103-n; electronic device 101 is also in communication with a services user 105. Via utilization of service optimization system 115, a service associated with electronic device 101 (for example, a data service, a messaging service, and/or the like) may be optimized.

Turning now to FIG. 1B, in other embodiments a service optimization system 115 may be (or may be operable on) an electronic device other than electronic device 101. Service optimization system 115 may be in communication with one or more service provider systems 103-A through 103-n, with services user 105, and/or with electronic device 101; electronic device 101 is also in communication with services user 105. Via utilization of service optimization system 115, a service associated with electronic device 101 (for example, a data service, a messaging service, and/or the like) may be optimized.

Turning now to FIG. 1C, in accordance with various embodiments, a services user 105 may perform tasks such as requesting, retrieving, receiving, updating, analyzing and/or modifying data. Services user 105 may also perform tasks such as initiating, manipulating, interacting with or using a software application, tool, module or hardware, and initiating, receiving or sending a communication. Services user 105 may interface with Internet server 125 via any communication protocol, device or method discussed herein, known in the art, or later developed. Services user 105 may be, for example, a customer of a utility, the owner of an electronic device such as mobile phone, and/or the like.

In various embodiments, a services user 105 may interface with a service optimization system 115 by way of a client 110. Service optimization system 115 may be a partially or fully integrated system comprised of various subsystems, modules and databases. Client 110 comprises any hardware and/or software suitably configured to facilitate entering, accessing, requesting, retrieving, updating, analyzing and/or modifying data. The data may include services data (for example, prices, availability, data caps, contractual requirements, and/or the like), or any other suitable information discussed herein.

Client 110 includes any device (e.g., a computer), which communicates, in any manner discussed herein, with service optimization system 115 via any network or protocol discussed herein. Browser applications comprise Internet browsing software installed within a computing unit or system to conduct online communications and transactions. These computing units or systems may take the form of personal computers, mobile phones, personal digital assistants, mobile email devices, laptops, notebooks, hand-held computers, portable computers, kiosks, and/or the like. Practitioners will appreciate that client 110 may or may not be in direct contact with service optimization system 115. For example, client 110 may access the services of service optimization system 115 through another server, which may have a direct or indirect connection to Internet server 125. Practitioners will further recognize that client 110 may present interfaces associated with a software application (e.g., a mobile device application) or module that are provided to client 110 via application GUIs or other interfaces and are not necessarily associated with or dependent upon internet browsers or internet specific protocols.

Services user 105 may communicate with service optimization system 115 through a firewall 120, for example to help ensure the integrity of service optimization system 115 components. Internet server 125 may include any hardware and/or software suitably configured to facilitate communications between the client 110 and one or more service optimization system 115 components.

Firewall 120, as used herein, may comprise any hardware and/or software suitably configured to protect service optimization system 115 components from users of other networks. Firewall 120 may reside in varying configurations including stateful inspection, proxy based and packet filtering, among others. Firewall 120 may be integrated as software within Internet server 125, any other service optimization system 115 component, or may reside within another computing device or may take the form of a standalone hardware component.

Authentication server 130 may include any hardware and/or software suitably configured to receive authentication credentials, encrypt and decrypt credentials, authenticate credentials, and/or grant access rights according to pre-defined privileges associated with the credentials. Authentication server 130 may grant varying degrees of application and/or data level access to users based on information stored within authentication database 135 and user database 140. Application server 142 may include any hardware and/or software suitably configured to serve applications and data to a connected client 110.

In accordance with various embodiments, service optimization system 115 is usable to evaluate aspects of particular services available to a user, make recommendations for selection and/or use of a particular service, implement provisioning of a service, implement a change to an alternative service, and/or the like. In particular, it will be appreciated that service optimization system 115 is necessarily rooted in computer technology and specialized computer networking components, as the service optimization methods associated therewith have not previously (and could not be) performed absent utilization of appropriate electronic systems (for example, simply in the mind of a user, or by a human with pen and paper). Continuing to reference FIG. 1C, service optimization system 115 allows communication with central data repository (CDR) 150, and with various other databases, tools, UIs and systems (not shown in FIG. 1C). Such systems include, for example, service provider systems, payment systems, financial systems, telecommunications networks, and/or the like.

Service optimization system 115 components are interconnected and communicate with one another to allow for a completely integrated optimization system. In various embodiments, service optimization system 115 allows a user to avoid overpaying for a suboptimal service. A services user 105 may select and/or utilize a service based at least in part upon the output of service optimization system 115.

In various embodiments, service optimization system 115 modules (e.g., service evaluation module 145, service provisioning module 147, and other service optimization system 115 modules not shown in FIG. 1C) are software modules configured to enable online functions such as sending and receiving messages, receiving query requests, configuring responses, dynamically configuring user interfaces, requesting data, receiving data, displaying data, executing complex processes, calculations, forecasts, mathematical techniques, workflows and/or algorithms, prompting services user 105, verifying user responses, authenticating the user, initiating service optimization system 115 processes, initiating other software modules, triggering downstream systems and processes, encrypting and decrypting, and/or the like. Additionally, service optimization system 115 modules may include any hardware and/or software suitably configured to receive requests from client 110 via Internet server 125 and application server 142.

Service optimization system 115 modules may be further configured to process requests, execute transactions, construct database queries, and/or execute queries against databases within service optimization system 115 (e.g., central data repository 150), external data sources and/or temporary databases. In various embodiments, one or more service optimization system 115 modules may be configured to execute application programming interfaces in order to communicate with a variety of messaging platforms, such as email systems, wireless communications systems, mobile communications systems, multimedia messaging service (“MMS”) systems, short messaging service (“SMS”) systems, and the like.

Service optimization system 115 modules may be configured to exchange data with other systems and application modules, for example telecommunications service provider systems. In various embodiments, service optimization system 115 modules may be configured to interact with other service optimization system 115 components to perform complex calculations, retrieve additional data, format data into reports, create XML representations of data, construct markup language documents, construct, define or control UIs, and/or the like. Moreover, service optimization system 115 modules may reside as standalone systems or tools, or may be incorporated with the application server 142 or any other service optimization system 115 component as program code. As one of ordinary skill in the art will appreciate, service optimization system 115 modules may be logically or physically divided into various subcomponents, such as a workflow engine configured to evaluate predefined rules and to automate processes.

In addition to the components described above, service optimization system 115 may further include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; a plurality of databases, and/or the like.

As will be appreciated by one of ordinary skill in the art, one or more service optimization system 115 components may be embodied as a customization of an existing system, an add-on product, upgraded software, a stand-alone system (e.g., kiosk), a distributed system, a method, a data processing system, a device for data processing, and/or a computer program product. Accordingly, individual service optimization system 115 components may take the form of an entirely software embodiment, an entirely hardware embodiment, or an embodiment combining aspects of both software and hardware. Furthermore, individual service optimization system 115 components may take the form of a computer program product on a non-transitory computer-readable storage medium having computer-readable program code means embodied in the storage medium. Any suitable computer-readable storage medium may be utilized, including magnetic storage devices (e.g., hard disks), optical storage devices, (e.g., DVD-ROM, CD-ROM, etc.), electronic storage devices (e.g., flash memory), and/or the like.

Client 110 may include an operating system (e.g., Windows, UNIX, Linux, Solaris, MacOS, iOS, Windows Mobile OS, Windows CE, Palm OS, Symbian OS, Blackberry OS, J2ME, etc.) as well as various conventional support software and drivers typically associated with mobile devices and/or computers. Client 110 may be in any environment with access to any network, including both wireless and wired network connections. In various embodiments, access is through a network or the Internet through a commercially available web-browser software package. Client 110 and service optimization system 115 components may be independently, separately or collectively suitably coupled to the network via data links which include, for example, a connection to an Internet Service Provider (ISP) over the local loop as is typically used in connection with standard wireless communications networks and/or methods, such as modem communication, cable modem, satellite networks, ISDN, digital subscriber line (DSL), and/or the like. In various embodiments, any portion of client 110 may be partially or fully connected to a network using a wired (“hard wire”) connection. As those skilled in the art will appreciate, client 110 and/or any of the system components may include wired and/or wireless portions.

Internet server 125 may be configured to transmit data to client 110, for example within markup language documents. “Data” may include encompassing information such as commands, messages, transaction requests, queries, files, data for storage, and/or the like in digital or any other form. Internet server 125 may operate as a single entity in a single geographic location or as separate computing components located together or in separate geographic locations. Further, Internet server 125 may provide a suitable web site or other Internet-based graphical user interface, which is accessible by users (such as services user 105). In various embodiments, Microsoft Internet Information Server (IIS), Microsoft Transaction Server (MTS), and Microsoft SQL Server, are used in conjunction with a Microsoft operating system, Microsoft NT web server software, a Microsoft SQL Server database system, and a Microsoft Commerce Server. In various embodiments, the well-known “LAMP” stack (Linux, Apache, MySQL, and PHP/Perl/Python) are used to enable service optimization system 115. Additionally, components such as Access or Microsoft SQL Server, Oracle, Sybase, InterBase, etc., may be used to provide an Active Data Object (ADO) compliant database management system.

Like Internet server 125, application server 142 may communicate with any number of other servers, databases and/or components through any means known in the art. Further, application server 142 may serve as a conduit between client 110 and the various systems and components of service optimization system 115. Internet server 125 may interface with application server 142 through any means known in the art including a LAN/WAN, for example. Application server 142 may further invoke software modules, such as service evaluation module 145, service provisioning module 147, and/or the like, automatically or in response to services user 105 requests.

Any of the communications, inputs, storage, databases or displays discussed herein may be facilitated through a web site having web pages. The term “web page” as it is used herein is not meant to limit the type of documents and applications that may be used to interact with the user. For example, a typical web site may include, in addition to standard HTML documents, various forms, Java applets, JavaScript, active server pages (ASP), common gateway interface scripts (CGI), Flash files or modules, FLEX, ActionScript, extensible markup language (XML), dynamic HTML, cascading style sheets (CSS), helper applications, plug-ins, and/or the like. A server may include a web service that receives a request from a web server, the request including a URL (e.g., http://yahoo.com) and/or an internet protocol (“IP”) address. The web server retrieves the appropriate web pages and sends the data or applications for the web pages to the IP address. Web services are applications that are capable of interacting with other applications over a communications means, such as the Internet. Web services are typically based on standards or protocols such as XML, SOAP, WSDL and UDDI.

Continuing to reference FIG. 1C, illustrated are databases that are included in various embodiments. An exemplary list of various databases used herein includes: an authentication database 135, a user database 140, CDR 150 and/or other databases that aid in the functioning of the system. As practitioners will appreciate, while depicted as separate and/or independent entities for the purposes of illustration, databases residing within service optimization system 115 may represent multiple hardware, software, database, data structure and networking components. Furthermore, embodiments are not limited to the databases described herein, nor do embodiments necessarily utilize each of the disclosed databases.

Authentication database 135 may store information used in the authentication process such as, for example, user identifiers, passwords, access privileges, user preferences, user statistics, and the like. User database 140 maintains user information and credentials for service optimization system 115 users (e.g., services user 105).

In various embodiments, CDR 150 is a data repository that may be configured to store a wide variety of comprehensive data for service optimization system 115. While depicted as a single logical entity in FIG. 1C, those of skill in the art will appreciate that CDR 150 may, in various embodiments, consist of multiple physical and/or logical data sources. In various embodiments, CDR 150 stores unique identification attributes including geo-location and cyber-location identifier information, scope and type of facility, single family/dwelling, multi-family dwelling, ownership status, lifestyle parameters and attributes such as ownership of various equipment, vehicles, and the like. For example, in various exemplary embodiments a data source or component database of CDR 150 includes information such as internet protocol (IP) address, postal and/or address information (for example, zip code, information for disambiguation of residence or mailing address, type of dwelling and/or facility, shared or single use, and/or the like), as well as other data such as device usage information, metered and/or collected information from a device or devices, duty cycle information, device use timing (peak, off-peak, etc), type of service selected (on-demand, subscription, etc.), personal behavior attributes of a customer, and/or the like.

It will be appreciated that information contained in CDR 150 may be regularly changing and/or updated. Accordingly, information in CDR 150 may be associated with indications of recency of data, completeness of data, and/or the like. Yet further, information contained in CDR 150 may include information directed to prices, scope of services, security of services, speed of services, and/or the like. Additionally, information contained in CDR 150 may be related to physical, functional, and/or provisioning constraints associated with a device, service, facility, and/or location. For example, a particular television owned by a consumer may be capable of displaying a 4K signal, but the telecommunications lines to the consumer's residence may not be capable of delivering a 4K signal; accordingly, selection of a 4K service provider in the area may be inappropriate as only a sub-optimal, lower-resolution signal is actually available at the consumer's residence.

In various embodiments, information in CDR 150 and elsewhere in service optimization system 115 is protected and secured, for example via access controls, encryption, and/or the like. In this manner, the privacy of users of service optimization system 115 is facilitated. Additionally, data exchanged between and among service optimization system 115 and other systems (for example, the mobile phone of a consumer) may be similarly secured and/or encrypted in order to protect the privacy and confidentiality of the user.

Any databases discussed herein may include relational, hierarchical, graphical, or object-oriented structure and/or any other database configurations. Common database products that may be used to implement the databases include DB2 by IBM (Armonk, N.Y.), various database products such as MySQL available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

One skilled in the art will also appreciate that, for security reasons, any databases, systems, devices, servers or other components of service optimization system 115 may consist of any combination thereof at a single location or at multiple locations, wherein each database or system includes any of various suitable security features, such as firewalls, access codes, encryption, decryption, compression, decompression, and/or the like.

The systems and methods may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, Flash, ActionScript, FLEX, VBScript, Macromedia Cold Fusion, COBOL, Microsoft Active Server Pages, assembly, PERL, SAS, PHP, awk, Python, Visual Basic, SQL Stored Procedures, PL/SQL, any UNIX shell script, and/or extensible markup language (XML) or the like, with the various algorithms being implemented with any combination of data structures, objects, processes, routines or other programming elements. Further, it should be noted that the system may employ any number of conventional techniques for data transmission, signaling, data processing, network control, and the like. Still further, the system may be used to detect or prevent security issues with a client-side scripting language, such as JavaScript, VBScript or the like.

Software elements may be loaded onto service optimization system 115. These computer program instructions may also be stored in a computer-readable memory that can direct a computer or other programmable data processing apparatus to function in a particular manner, such that the instructions stored in the computer-readable memory produce an article of manufacture including instruction means which implement the function specified herein or in flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, web sites, web forms, prompts, etc. Practitioners will appreciate that the illustrated steps described herein may comprise any number of configurations including the use of windows, web pages, web forms, popup windows, prompts and/or the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

With continued reference to FIG. 1C, in various embodiments, services user 105 logs onto an application (e.g., a module) and Internet server 125 may invoke an application server 142. Application server 142 invokes logic in the service optimization system 115 modules by passing parameters relating to service user's 105 requests for data. Service optimization system 115 manages requests for data from service optimization system 115 modules and/or communicates with other system components. Transmissions between services user 105 and Internet server 125 may pass through a firewall 120 to help ensure the integrity of service optimization system 115 components. Practitioners will appreciate that exemplary embodiments may incorporate any number of security schemes or none at all. In various embodiments, Internet server 125 receives requests from client 110 and interacts with various other service optimization system 115 components to perform tasks related to requests from client 110.

Internet server 125 may invoke an authentication server 130 to verify the identity of services user 105 and assign roles, access rights and/or permissions to services user 105. In order to control access to the application server 142 or any other component of service optimization system 115, Internet server 125 may invoke an authentication server 130 in response to services user 105 submissions of authentication credentials received at Internet server 125. In response to a request to access service optimization system 115 being received at Internet server 125, Internet server 125 determines if authentication is required and transmits a prompt to client 110. Services user 105 enters authentication data at client 110, which transmits the authentication data to Internet server 125. Internet server 125 passes the authentication data to authentication server 130 which queries the user database 140 for corresponding credentials. In response to services user 105 being authenticated, services user 105 may access various applications and their corresponding data sources.

With continued reference to FIGS. 1A, 1B, and 1C, electronic device 101 is configured with network connectivity to provide inputs and outputs to identify and select the corresponding service options and capabilities. In various exemplary embodiments, electronic device 101 comprises one or more of a smartphone, tablet, cable box, utility meter, laptop computer, desktop computer, and/or the like.

In operation, service optimization system 115 may rank available services and display the ranking to services user 105. If the optimal service is not available, service optimization system 115 may select the next-best option. Moreover, it will be appreciated that service optimization system 115 may be configured with (or configured for the use of) multiple receivers, transmitters, transceivers, and/or the like, in order to communicate with various service providers and/or electronic devices. Additionally, service optimization system 115 may be configured to utilize services user 105 input, for example via menu driven system, in order to select and provision services. For example, service optimization system 115 may be operable as software installed on a desktop computer or cell phone.

In some embodiments, service optimization system 115 is local to electronic device 101. In other embodiments, service optimization system 115 is remote from electronic device 101, for example accessible over a packet switched network. Moreover, multiple service optimization systems 115 may be utilized, for example a first service optimization system 115 for selection of a utility service, and a second service optimization system 115 for selection of a mobile telephone data plan service.

In certain embodiments, service optimization system 115 is configured to communicate with a payment provider to authorize payment for a service selected for electronic device 101. This communication may be encrypted for security.

In various embodiments, service optimization system 115 is configured to create and/or discover sub-networks and/or communications pathways associated with a particular device. For example, service optimization system 115 may be configured for auto-discovery of adjacent networked devices in an ecosystem, an ad-hoc network, and/or the like. In this manner, service optimization system 115 may become aware of and/or utilize additional services and/or communications pathways as such services and/or pathways are brought on- and off-line.

Moreover, service optimization system 115 may be configured for use with “Internet of Things” (IOT) devices, for example networked sensors, switches, cameras, light bulbs, appliances, and/or the like. Service optimization system 115 may be configured to account for and/or utilize the capabilities of such devices when determining an optimal service for a particular device and/or usage scenario. As additional IOT devices are added to a particular network, or as devices are removed from a network, service optimization system 115 may recalculate and/or update recommendations for an optimal service for a particular device or devices under the new usage environment.

Additionally, it will be appreciated that service optimization system 115 may be utilizable in connection with a single, stand-alone device, for example a mobile telephone. However, service optimization system 115 may also be utilizable in connection with “bundled” devices and/or services, for example a mobile telephone and cable box having services associated with a common service provider and/or a common billing structure.

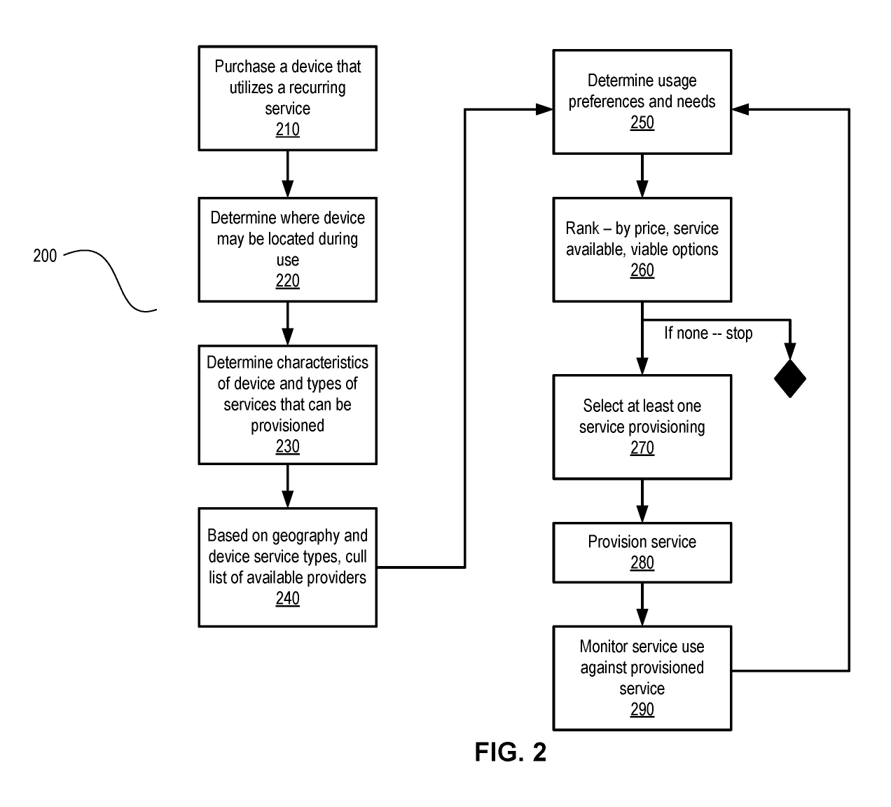

With reference now to FIG. 2, in various embodiments a method for optimizing a service comprising identifying and/or characterizing an electronic device 101 in connection with an associated service (step 210). For example, a smartphone may be purchased, relocated to a new location, re-purposed for use on a different wireless network, and/or the like.

Via geolocation services, network-provided location information, hard-coded location information, or other suitable approach, location information associated with electronic device 101 is evaluated by service optimization system 115 (step 220). Based at least in part on the location information, a list of available services for electronic device 101 may be obtained. It will be appreciated that the available services may change based on current or historical location information for electronic device 101.

Based in part on the location information, capabilities of electronic device 101, preferences of systems user 105, and/or the like, service optimization system 115 determines the characteristics of services that can be provisioned for electronic device 101 (step 230). In certain embodiments, this evaluation is conducted by services evaluation module 145 in optimization system 115. Certain providers and/or services may be culled from the list of available services, for example due to pricing constraints, contractual limitations, geographic limitations, and/or the like (step 240).

At this point, systems user 105's usage pattern, profile and preferences associated with electronic device 101 may be determined (step 250). Upon initial setup of an electronic device 101, this step may be performed by systems user 105 to indicate an estimated use pattern and requirements or needs based on prior experience, such as replacing an existing electronic device 101 with a new one. In the case of long-term actual behavior (for example, historical information and/or feedback available in and/or to service optimization system 115) systems user 105's usage and needs profile/requirements can be refined and amended.

Based at least in part on the foregoing, service optimization system 115 computes a rank (weighted by factors—such as price, minimum needs, brand preference, etc.) for the available services and service options (step 260). For example, for the case when electronic device 101 is a smartphone, service optimization system 115 may calculate the best fit of services, prices, terms, cancellation conditions/penalties, etc. for the smartphone. Additionally, in the event there are no services available for electronic device 101 in light of the input criteria, service optimization system 115 provides an indication to services user 105 that there are no viable service options available.

Continuing to reference FIG. 2, at this point service optimization system 115 provides options for services user 105 to select one or more services options for electronic device 101 (step 270). It will be appreciated that certain devices, such as smartphones, are able to be provisioned by multiple providers. For example, via operation of services provisioning module 147, service optimization system 115 provides the necessary information to a service provider to enable provision of the selected service or services to electronic device 101. It will be appreciated that provisioning may include updates to the internal configuration of electronic device 101, wired and/or wireless inputs, or the like.

In various exemplary embodiments, in connection with provision of a service for electronic device 101, service optimization system 115 may communicate the service request from electronic device 101 (e.g., in the form of a contract that can be electronically proffered and made available) to services user 105 and/or a services provider (step 280). In this manner, services associated with electronic device 101 may be authorized, implemented, and brought on-line without direct interaction between services user 105 and the corresponding services provider. It will be appreciated that in the case of an initial service offering, this may or may not be possible.

Once services are being provided to electronic device 101 from one or more service providers, service optimization system 115 can observe, monitor, and otherwise evaluate the provided service (step 290). The results of the evaluation may be provided as an input to a repeated step 250, for example in order to determine if the current service is optimal, or if a better option exists. For example, factors which may influence the evaluation of which service is optimal include: the existence of a pricing promotion or sale, the entrance of a new provider for an existing service, the existence of a new service, an updated location for electronic device 101, and/or the like.

For example, in an embodiment wherein service optimization system 115 comprises a mobile application operative on an electronic device 101 configured as a smartphone, service optimization system 115 may detect that the smartphone has been relocated from a first geographic location to a second geographic location. In the second geographic location, a wireless data plan for electronic device 101 exists that did not exist in the first geographic location. The wireless data plan is both faster and cheaper. Service optimization system 115 detects the new, optimal service, and prompts services user 105 to confirm the changeover of electronic device 101 to utilize the new service. Upon confirmation from services user 105, service optimization system 115 provisions electronic device 101 for the new service, saving money for services user 105 and allowing improved performance and usability of electronic device 101. Via operation of principles of the present disclosure, performance of electronic devices is improved.

Having thus described different embodiments of the invention, other variations and embodiments that do not depart from the spirit of the invention will become apparent to those skilled in the art. The scope of the present invention is thus not limited to any particular embodiment, but is instead set forth in the appended claims and the legal equivalents thereof. Unless expressly stated in the written description or claims, the steps of any method recited in the claims may be performed in any order capable of yielding the desired result.

While the present disclosure may be described in terms of a user, an electronic device, and so forth, one skilled in the art can appreciate that similar features and principles may be applied to other services systems, such as, for example, electricity services, trash services, professional services, transportation services, and/or the like.

While the exemplary embodiments described herein are described in sufficient detail to enable those skilled in the art to practice principles of the present disclosure, it should be understood that other embodiments may be realized and that logical and/or functional changes may be made without departing from the spirit and scope of the present disclosure. Thus, the detailed description herein is presented for purposes of illustration and not of limitation.

For the sake of brevity, conventional data management, computer networking, statistical assessment, software application development, and other aspects of exemplary systems and methods (and components thereof) may not be described in detail herein. Furthermore, the connecting lines shown in the various figures contained herein are intended to represent functional relationships and/or physical or communicative couplings between the various elements. It should be noted that many alternative or additional functional relationships or physical connections may be present in a practical service optimization system.

While the description references specific technologies, system architectures and data management techniques, practitioners will appreciate that this description is of various embodiments, and that other devices and/or methods may be implemented without departing from the scope of principles of the present disclosure. Similarly, while the description references a user interfacing with the system via a computer user interface, practitioners will appreciate that other interfaces may include mobile devices, kiosks and handheld devices such as mobile phones, smart phones, tablet computing devices, etc.

While the steps outlined herein represent exemplary embodiments of principles of the present disclosure, practitioners will appreciate that there are any number of computing algorithms and user interfaces that may be applied to create similar results. The steps are presented for the sake of explanation only and are not intended to limit the scope of the present disclosure in any way. Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all of the claims.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. After reading the description, it will be apparent to one skilled in the relevant art(s) how to implement principles of the disclosure in alternative embodiments.

It should be understood that the detailed description and specific examples, indicating exemplary embodiments, are given for purposes of illustration only and not as limitations. Many changes and modifications may be made without departing from the spirit thereof, and principles of the present disclosure include all such modifications. Corresponding structures, materials, acts, and equivalents of all elements are intended to include any structure, material, or acts for performing the functions in combination with other elements. Reference to an element in the singular is not intended to mean “one and only one” unless explicitly so stated, but rather “one or more.” Moreover, when a phrase similar to “at least one of A, B, or C” or “at least one of A, B, and C” is used in the claims or the specification, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

What is claimed is:

1. For selecting a service plan, a method comprising the steps of:
(a) determining by querying a device, a location at which the service is being provided;
(b) determining based on the location, a plurality of competing services that are provided in that location;
(c) determining the usage rate and other variables of the provided service; and
(d) based on the factors in (c), selecting the most cost-effective service.

2. The method of claim 1, wherein the other variables are one or more of: (a) usage rates of the service by time of day and/or day of the week; (b) usage rates for the service by time of day and/or day of the week; (c) length of any existing contract for the service; (d) the cost of breaking any existing contract; (e) the term of new customer rates; (f) service features unique to the location; and (g) available discounts.

3. The method of claim 2 wherein the services unique to the location include one or more of: (a) television service suppliers; (b) electricity; (c) water; (d) phone; (e) mobile phone; and (f) internet.

4. The method of claim 1 wherein the device is one or more of: (a) an electric meter; (b) a television cable box; (c) a water meter; (d) an internet router; (e) a computer server; (f) a cell phone; and (g) a computer.

5. The method of claim 1, wherever there is only one available service provider that has multiple service plans, and the most cost-effective service is selected from among the plans.

6. The method of claim 1, further comprising repeating steps (a) through (d) to select a new service.

7. A device for determining an optimal service plan, the device comprising:
(a) a receiver for receiving service plan information from one or more service providers;
(b) a database wherein the service providers and service plans for each particular service are maintained;
(c) a receiver for receiving information about a user's requirements for one or more services; and
(d) a processor for comparing the user's requirements for one service to the available plans for that service, and selecting the optimal service for the user.

8. The device of claim 6 that further includes a transmitter to transmit the optimal service selection to one or more of the user and the service provider that provides the optimal service.

9. The device of claim 7 wherein a transmission to the service provider further includes an order for the optimal service to be provided to the user.

10. The device of claim 7 wherein the receiver receives a message from the service provider confirming that the order for the optimal service has been filled, and the date on which the optimal service will start to be provided to the user.

11. The device of claim 7 wherein the transmission to the user is sent to the user by one or both of an email message and a text message.

12. The device of claim 9 wherein the transmission to the user is sent to the user by one or both of an email message and a text message.

13. The device of claim 6 wherein the receiver receives information wirelessly.

14. The device of claim 6 wherein the receiver receives information wirelessly and via a wired connection.

15. The device of claim 8 wherein the transmission also includes billing information for the service provider to bill the user.

16. The device of claim 6 wherein the receiver is a cellular telephone.

17. A service optimization system for a plurality of electronic devices, the service optimization system comprising:
a first electronic device;
a second electronic device, wherein the first electronic device and the second electronic device comprise one or more of: (a) an electric meter; (b) a television cable box; (c) a water meter; (d) an internet router; (e) a computer server; (f) a cell phone; and (g) a computer; and
a service optimization device in communication with the first electronic device and the second electronic device, wherein the service optimization device comprises:
(a) a receiver for receiving service plan information from one or more service providers;
(b) a database wherein the service providers and service plans for each particular service are maintained;
(c) a receiver for receiving information about a user's requirements for one or more services; and
(d) a processor for comparing the user's requirements for one service to the available plans for that service, and selecting the optimal service for the user.

18. The system of claim 17 wherein the service optimization further includes a transmitter to transmit the optimal service selection to one or more of the user and the service provider that provides the optimal service.

19. The system of claim 17 wherein a transmission to the service provider further includes an order for the optimal service to be provided to the user.

20. The system of claim 17 wherein the first electronic device and the second electronic device receive services at a common location.
